(19) United States
(12) Patent Application Publication
(10) Pub. No.: US 2013/0167136 A1
(43) Pub. Date: Jun. 27, 2013

(54) COMPONENT-BASED INSTALLATION

(71) Applicant: Oliver Goldman, Redwood City, CA (US)

(72) Inventor: Oliver Goldman, Redwood City, CA (US)

(73) Assignee: Adobe Systems Incorporated, San Jose, CA (US)

(21) Appl. No.: 12/406,867

(22) Filed: Mar. 18, 2009

(51) Int. Cl. G06F 9/445

(52) U.S. Cl. 717/175

(57) ABSTRACT

Methods, systems, and apparatus, including computer programs encoded on a computer storage medium, for installing software. In one aspect, a method includes receiving information regarding software elements, which form a software program, each of the software elements including one or more files, creating software element descriptors corresponding to the software elements, wherein each software element descriptor specifies the one or more files that are included in a respective software element, and generating a deployment package including the software element descriptors for installation of the software program, wherein each software element is separately addable and updatable in the software program, using a corresponding software element descriptor, after the software program has been installed on a computer.

### BACKGROUND

This specification relates to installing and updating software, including application execution environments (e.g., virtual machines and runtime environments), on a computer platform. A computer platform is a computer including a particular operating system (OS) for that computer (e.g., WINDOWS® OS, MAC® OS, or LINUX® OS). Software developers often create source code that can be appropriately compiled for respective computer platforms, and then independently generate installation packages for each target platform. Each native installation package is associated with a specific computer platform, and these installation packages can then be distributed for installation on appropriate machines. For a particular target platform, the appropriate installation package is obtained from the software developer, and an OS installer can be used to process the native installation package in order to install the application. For example, INSTALLSHIELD® software can be used to produce an .msi file for installation on WINDOWS® machines, and a different software tool can be used to produce .pkg files for installation on MAC® machines.

Some software developers have created cross-platform installation packages, such as the JAVA® Archive (JAR) file format, that get deployed to the end-user system. The cross-platform package can then be expanded (e.g., decrypted and uncompressed) and written directly to disk using code provided by the software developer and/or the developer of the cross-platform package format. Typically, such cross-platform software relies on a previously installed virtual machine, such as the JAVA® Virtual Machine (JVM) (available from Sun Microsystems, Inc.), to run on the target platform.

The JVM provides a runtime environment and Java interpreter for most operating systems, including WINDOWS® OS, MAC® OS, AND LINUX® OS. Java source code files (files with a .java extension) are compiled into a format called bytecode (files with a .class extension), which can then be executed by a Java interpreter. Bytecode can be converted directly into machine language instructions by a just-in-time compiler (JIT). Other example runtime environments include the C runtime, .NET, and the Adobe® AIR™.

Flash® Player (available from Adobe Systems Incorporated) is another virtual machine, which is used to run, or parse, Flash® files including ActionScript or Shockwave Flash (SWF). The Flash® Player and Flash® Authoring software allow development of projectors (self-running SWF movies) that run on a specific target platform, by embedding the SWF data in the Flash® Player executable to create a new .exe file, and manipulating a byte pattern in the .exe file to indicate the presence of the SWF data. Such projectors can then be distributed for use on the target platform.

### SUMMARY

This specification describes technologies relating to software installation and updating. In general, one innovative aspect of the subject matter described in this specification can be embodied in methods that include the actions of receiving information regarding software elements, which form a software program, each of the software elements including one or more files; creating software element descriptors corresponding to the software elements, wherein each software element descriptor specifies the one or more files that are included in a respective software element; and generating a deployment package including the software element descriptors for installation of the software program, wherein each software element is separately addable and updatable in the software program, using a corresponding software element descriptor, after the software program has been installed on a computer. Other embodiments of this aspect include corresponding systems, apparatus, and computer program products.

Another innovative aspect of the subject matter described in this specification can be embodied in methods that include the actions of obtaining a deployment package including software element descriptors, the software element descriptors corresponding to software elements used to install a software program; determining that the software elements are located on a target device; and initiating installation of the software program on the target device using the software elements. Other embodiments of this aspect include corresponding systems, apparatus, and computer programs, configured to perform the actions of the methods, encoded on computer storage devices.

These and other embodiments can optionally include one or more of the following features. An indication of a first feature associated with the software program can be received, a determination is made that a first software element corresponding to the first feature is not located on the target device, the first software element is downloaded from a remote site, installation of the first software element is initiated, and functionality associated with the first feature is provided.

A determination is made that a second software element descriptor requires a third software element to be installed before a second software element corresponding to the second software element descriptor can be installed, a determination is made that the third element is not located on the target device, the third software element is downloaded from a remote site, and installation of the second and the third software element is initiated.

An installable image can be created using the first software element and the second software element. An installable package can be created from the installable image, wherein the installable package is platform specific. Initializing installation can include initiating installation using the installable package. Initializing installation can also include initiating installation using the installable image. The first software element can be located on the target device as part of a previous installation of the software program. A determination can be made that one of the software elements has been updated. An updated version of the software element that has been updated can be obtained. Installation of the software program can be initiated using the updated version of the software element. A first signature associated with each of the software elements that are downloaded can be identified, and the first signature can be validated using the software program. The software element descriptors can be stored as metadata in the installable package. Each software element can include a version. The software element descriptors can define dependencies between a respective software element and other software elements.

Particular embodiments of the subject matter described in this specification can be implemented so as to realize one or more of the following advantages. New features for the software program can be downloaded and installed without re-publishing the entire software program. A software program can also be updated without re-downloading the entire software program. Incremental updates can be produced without requiring a previous version of the software program.

In order to update the software program, a new image of the software program does not need to be generated to create a patch for the update. Also, many different images do not need to be created in order to create patches to cover updates. Furthermore, updates do not have to be applied in a strictly-ordered sequence.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram showing an example system for software distribution and installation.

FIG. 2 is a block diagram showing an example deployment package being created and installed on a target platform.

FIG. 3 is a flow chart showing an example method of installing software.

FIG. 4 is a flow chart showing another example method of installing software.

FIG. 5 is a flow chart showing another example method of installing software.

Like reference numbers and designations in the various drawings indicate like elements.

### DETAILED DESCRIPTION

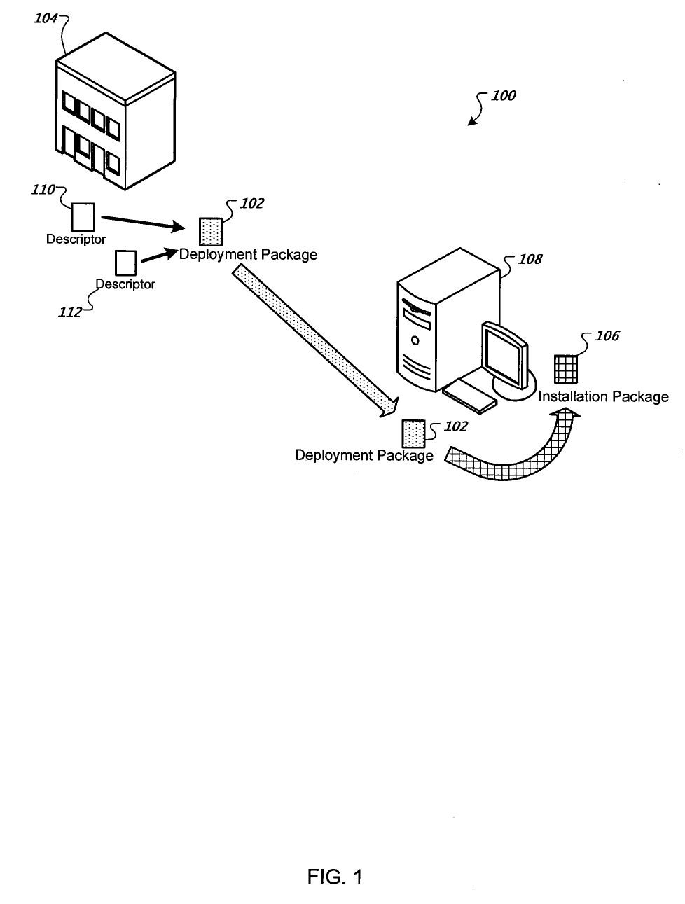

FIG. 1 is a block diagrams showing an example system 100 for software distribution and installation. The system 100 can be used to install software programs on various different platforms and can simplify updates to the installation as well as installation of optional features of the software programs. As used herein, a “software program” refers to a computer program that the user perceives as distinct computer tool used for a defined purpose. A software program may rely on a runtime library to operate. A software program can also refer to a runtime. The example of FIG. 1 is a detailed example and the subject matter of this application is not limited to cross-platform example.

In the example system 100, a single deployment package 102 that is cross-platform can be used to install a software program on multiple, different machines. A user, such as an end user or administrator, can obtain the deployment package 102 from a distributor 104 to create a platform specific installation package 106 corresponding to a target computer 108. The installation package 106 can be used to install the software program on the target computer 108. In some cases, the installation packages 106 can be generated using the deployment package 102 for installation on computers other than the target computer 108, some of which can have the same platform as the target computer 108, and some of which can have different platform(s) than the target computer 108.

The distributor 104 makes a deployment package 102 available. The distributor 104 can be a software developer, publisher, reseller, or other entity which distributes software. The distributor 104 makes available a deployment package which includes software element descriptors 110 and 112 that are used for installing the software program. The software program can be broken up into one or more software elements. Each software element can, for example, correspond to a different part of the software program. Each software element includes one or more files that are used to install the particular software element. The descriptors 110 and 112 include the names of the files that are needed to install the corresponding software element. The descriptors 110 and 112 can each be part of the element to which they correspond.

The user can obtain the deployment package 102 from the distributor 104. The deployment package 102 can be distributed on physical media, such as Compact Discs (CDs), Digital Versatile Discs (DVDs), floppy disks, etc., via networks, such as Local Area Networks (LANs), the Internet, peer to peer links, wireless networks, etc., by being preinstalled on computer equipment, such as hard drives, flash drives, portable music players, etc., or any other technique that can be used to deliver digital content.

The deployment package 102 can first be handled by enabling software, such as the virtual machine, and/or runtime library described further below. This enabling software checks whether the software program has already been installed, and if not, installs the software program using the techniques described herein.

An installation package 106 can be created from the deployment package 102. In some implementations, once the deployment package 102 is received, the virtual machine can be used to create the installation package 106 from the deployment package 102. An installer program can run on the user's computer and use the descriptors 110 and 112 to generate the installation package 106 specific to the platform of the target computer 108.

The user can install the software program using the installation package 106 generated from the deployment package 102. The installation package 106 can use the operating system installer to install the software program; this enables use of the installation procedures that are native to the platform. Maintenance performed on the target computer, e.g., setup, reinstallation, removal, etc., can be done using the utilities native to the OS. In some implementations, execution of the installation package 106 can be initiated automatically after generation of the installation package 106.

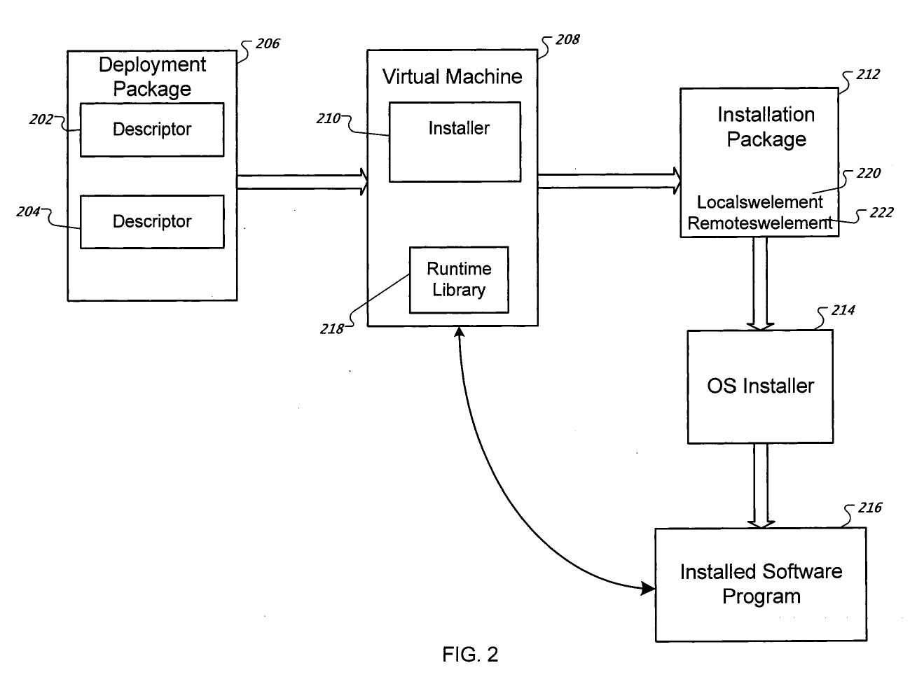

FIG. 2 is a block diagram showing an example deployment package being converted to an installation package and installed on a target platform. A runtime installer 210 can create an installation package (e.g., a single install file on the target computer), which an OS installer can use to install a software program on a target computer.

A deployment package 206 can include software descriptors 202 and 204. The descriptors 202 and 204 can include the names of the files that are needed to install each software element of the software program. A virtual machine 208 (which can be located on the target computer or another computer) can include the runtime installer 210, which creates an installation package 212 using the descriptors 202 and 204 from the deployment package 206. An operating system installer 214 can use the package 212 to install a platform specific software program 216 on a target computer.

The software descriptors 202 and 204 describe the files that are needed to install each of the software elements corresponding to each descriptor. The descriptors 202 and 204 can be stored in extensible Markup Language (XML) or other platform independent format. For example, the deployment package 206 can be stored as a compressed and/or encrypted file (e.g., a Zip file), and the descriptors 202 and 204 can be stored in an XML file included within the compressed and encrypted file. This XML file can contain information used by the installer 210, such as the files that are needed for each software element to be installed as part of the software program. In general, the descriptors 202 and 204 can include a list of all the files an installation sequence uses, but abstracted away from platform-specific notions.

The installer 210 can be included with a virtual machine 208. The virtual machine 208 is a runtime environment that provides software services for processes or programs while a computer is running. The virtual machine 208 includes the runtime library 218, which is a collection of utility functions that support a program while it is running, often working with the OS to provide facilities. It should be appreciated that the runtime library 218 and the virtual machine 208 can be considered one and the same in some implementations. The virtual machine 208 can be client-based software that runs supports vector and raster graphics, bidirectional streaming of audio and video and one or more scripting languages (e.g., ActionScript). Inclusion of the installer 210 with the virtual machine 208 can be implemented by building the installer's functionality directly into the virtual machine 208 or by simply associating the installer 210 with the virtual machine 208, such that they are delivered as a package together.

Moreover, the installer 210 can be a stand alone program (e.g., a platform specific program in native machine code), interpreted and/or partially compiled code that relies on the runtime library 218 to operate (e.g., SWF code), or a combination of these.

A user can obtain and install the installer 210 and/or virtual machine 208 for installing a first software program, then subsequently reuse the installer 210 and/or virtual machine 208 for installation and/or software support. The installer 210 and virtual machine 208 can be made available for multiple different platforms (e.g., different platform specific versions of the installer 210 and virtual machine 208 can be freely distributed, such as over a public network or by pre-installation on computer equipment prior to sale). If the installer 210 and/or virtual machine 208 are not already present on a given machine, they can be included with the deployment package 206 as well. In some implementations, the installer 210 can run natively on a generating computer without requiring a virtual machine. In some implementations, use of a virtual machine can increase portability of an installer by reducing the number of installers developed for generating OS installation packages. In some implementations, the installer 210 can have the ability to generate multiple installation packages for different target platforms.

Moreover, the installer 210 can be pre-installed and include a copy of the runtime library 218, and the installer 210 can add the runtime library 218 to the installation package 212 so that the runtime library 218 is installed on the target computer along with the software program 216. The runtime library 218 can be bound to the software program 216 (i.e., a dedicated copy of the library 218, which only the software program 216 can use), or the runtime library 218 can be simply bundled with the software program 216 (i.e., the library 218 is installed along with the software program 216, but is then available for other software programs on the target computer).

The installer 210 can generate an installation package 212 using the deployment package 206. The installer 210 can use the software descriptors 202 and 204 included in the deployment package 206 to generate the installation package 212.

The installer 210 can first determine that the software elements corresponding to the software element descriptors 202 and 204 are local on the target device. The installer 210 can acquire the software elements from the installed runtime or the installed image. The installer 210 reads the descriptors 202 and 204 to determine which software elements are needed for each software element. The installer 210 gathers the software elements that are local 220 and gathers the files for each of the software elements and copies all of them into a staging directory. The staging directory can then collate all of the files into a single installable image.

If, however, one of the descriptors 202 or 204 referred to a dependency on another software element, as will be described below, then the installer 210 can determine if the depended on software element is local and if the software element is not local, then the installer 210 can download the depended on software element from a remote site.

The staging directory can be a files system tree containing the same files and directories as will be present when the software program is installed. For example, suppose two software elements A and B contained files A1, A2, B1, and B2.

The layout of software element A may be:

dir1/A1

dir2/A2

The layout of software element B may be:

dir1/B1

dir2/B2

The staging directory for a software program including just the two software elements A and B would be:

dir1/A1

dir1/B1

dir2/A2

dir2/B2

Various scenarios can initiate the process of an element that needs to be added or updated. For example, a software program can include an optional feature, A. A user can take some action to trigger the use of feature A. The software program can respond by requesting that the installer 210 install the element containing the implementation of A. The installer 210 can then combine the existing, already installed elements with the additional element containing A to create the new installable image. Then the installer 210 re-installs the application from that image. After that, feature A is installed.

The software elements can also declare dependencies on other elements. For example, an element A can only be installed if an element B is also being installed. The installer 210 can determine if element B is located on the target device. If element B is not located on the target device, the installer 210 can download element B from a remote site, install element B, and then continue installation of the software program and element A.

The dependencies can also depend on versions. For example, an element C can only be installed if version 2.0 of an element D is also to be installed. The dependencies can be listed in the software descriptors 202 and 204. The element dependencies can be included in the descriptor for some element. For example, an element dependencies may look like the following:

```
<element>
    <name>A</name>
    <requires>
        <requiredElement name=“B”/>
        <requiredElement name=“C” minimumVersion=“1.5”/>
    </requires>
</element>
```

In the previous example of the element dependency, the dependency for element A requires that Element B be installed before A can be installed. The dependency also requires that version 1.5 of element C be installed as well before element A can be installed.

The installation package 212 can then be created from the installable image depending on the OS. The installable image can be created in different ways depending on the OS. On a WINDOWS® OS based computer, the installable image can be created as follows. A template .msi file can be copied, and all subsequent steps operate on this copy. For each directory in the image, an entry is created in the component table in the .msi file. For each file in the image, an entry is created in the file table. For each file, an association is created between the file entry and the component entry for the directory in which the file appears.

The installation package 212 can include a compressed archive file (e.g., a Zip file) into which a single copy of the software program has been packaged. Upon execution, the self-extractor code can unarchive the software program to a temporary location. The software program can be designed so that it can be run in place, i.e., without requiring an installation step other than simply copying files. Thus, the extracted copy of the software program is immediately useable for running the installer.

The generation process creates the installation package 212 in a format specific to the target platform, e.g., .msi file for a Windows® operating system. Since the installation process uses the platform's installer, the installation process can proceed as though the installation package was developed specifically for that target, i.e. installation and maintenance follows the operating system installation procedure(s) the user is familiar with on his or her computer.

On a MAC® OS based computer, the installation package 212 can be the installable image, and installation can proceed from this image. On a WINDOWS® OS based computer, additional platform specific files can be created before the installation can be performed. When generation of the installation package 212 is complete, the installer 210, or the virtual machine 208, can initiate the operating system installer 214. In some implementations, the operating system installer 214 can be automatically invoked when generation is complete. In some implementations, the user can choose to manually execute the installation package 212 at a later time or transfer the installation package 212 to another computer.

The target computer's operating system installer 214 can be used to install the software program in a fashion that is natural for the platform. For example, computers running a WINDOWS® operating system can use an .msi file to control software program installations; an operating system user interface can be used to perform maintenance functions on a software program installed using an .msi file, such as reinstalling, adding components to, or removing the software program.

On a WINDOWS® OS based computer, the installer 210 can operate using API(s) that are in the runtime and that are related only to installation because they use the WINDOWS® installation services to perform the installation operations. On a MAC® OS based computer or a LINUX® OS based computer, the installer 210 can operate using the file system API(s) that are in the runtime. In any event, the runtime installer class can define a cross-platform interface that installer(s) can access and use in the same manner, regardless of whether it is running on a MAC® OS based computer or a WINDOWS® OS based computer (i.e., the installer need not have any native code in it).

Each of the software elements that form the software program can be separately updated after the software program has been installed. If the updated software element does not already exist on the target device for example, from a previous installation of another software program, the updated element is downloaded. The installer 210 can check to determine if the updated element, whether it is local or needs to be downloaded, declares dependencies on any other elements. The dependencies can, for example, include whether other software elements need to be updated before the downloaded element can be installed. The installer 210 can recursively download the other elements and satisfy their dependencies.

All the new downloaded software elements can be copied into a directory on the local file system. The installer 210 can copy each of the software elements that are already installed and not being updated into the same directory as the updated elements. The installer 210 can use the descriptors 202 and 204 to determine which software elements are needed for the installation of the software program and copy the preexisting elements that are not being updated into the directory. The directory now contains a complete image of the updated software program. The installer 210 can convert it into an installation package 210 as described above and the installation package can be used to install the update.

For example, suppose a media application needs a digital rights management (DRM) software element in order to function properly. The media application can notify a user through a user interface that the DRM software element is needed and the installer 210 can proceed with determining whether the DRM softer element has been installed for a previous software program. If it is determined that the DRM element has not been installed, the DRM element can be downloaded form a remote site. The installer 210 copies all of the elements for the media application already on the remote computer into a temporary directory and after the DRM element is downloaded, copies the DRM element into the directory as well. The directory now contains a complete image of the media application. An installation package can then be created from the image and the media application can be installed.

In another example, suppose the media application needs DRM version 2.0 and currently only DRM version 1.0 is installed. The updated version of the DRM software element can be downloaded from a remote site and copied into the temp directory along with the other software elements of the media application. The installer 210 knows which software elements are include in the media application because of the descriptors 202 and 204 that were included in the deployment package. Once all the files of the software elements are copied into the directory along with the updated DRM element, the directory again includes a new image of the media application. An installation package can be created from the image and the media application can be installed.

In some implementations, the installer 210 can use multiple template executables and one or more template installation packages to create the installation package 212. Program information can be obtained for installing a software program on a target platform.

The program information can include, for example, a software program name, a software program icon, version information, and software program code. The program information can be used to form a software program executable for installation on a target computer. The target computer can be checked to determine whether a current version of the software program is installed. A template executable can be obtained which includes machine code native to the target platform. This machine code enables the executable to run as a native software program on the target platform. The software program executable can be placed into an install directory using a file name corresponding to the software program name.

In some implementations, the deployment packages 206 can be used to install a software program, while in other implementations the deployment package 206 can be a runtime environment (RE) program package used to install a runtime environment on which software programs depend for operation. The runtime environment can be a cross-platform runtime environment, such as the Adobe® AIR™ software, provided by Adobe Systems Incorporated of San Jose, Calif.

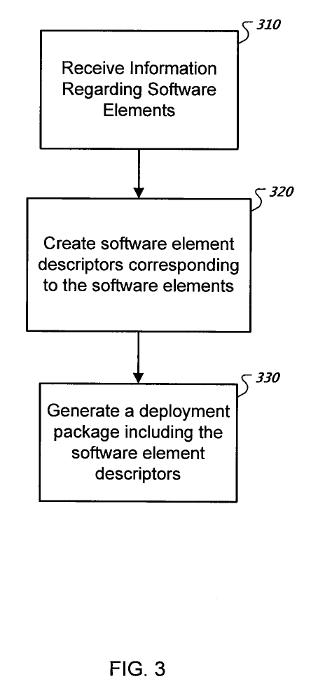

FIG. 3 is a flow chart showing an example method of creating a deployment package. The method includes receiving information, creating descriptors, and generating a deployment package to install a software program on a target device. The target device can be one of several, different platforms.

Information regarding software elements can be received 310 for installing a software program. The software elements can form the software program, and each of the software elements can include one or more files that are needed to install the respective element. Each of the software elements can include a version and are each cross specific. Each of the software elements can be local or remote to a device on which the software program corresponding to the software element is installed.

Software element descriptors can be created 320 corresponding to the software elements. Each of the software element descriptors can specify the one or more files that are included in a respective software element. The software element descriptors can be cross-platform descriptors. The software element descriptors can define dependencies between elements. The descriptors can be stored in XML data as follows:

```
<component xmlns = ‘URL - 1’>
    <patchLevel> 4880 </patchLevel>
    <manifest>
        <file> DRM.dll</file>
    </manifest>
</component>
```

As shown in this example, the XML data includes Universal Resource Locator (URL) data for the files of the descriptor.

A deployment package can be generated 330 that includes the software element descriptors. The deployment package can be used to install the software program. The software element descriptors can be stored as metadata in the deployment package. The software element descriptors can be separately updated as well as separately added at a later time after the initial installation of the software program.

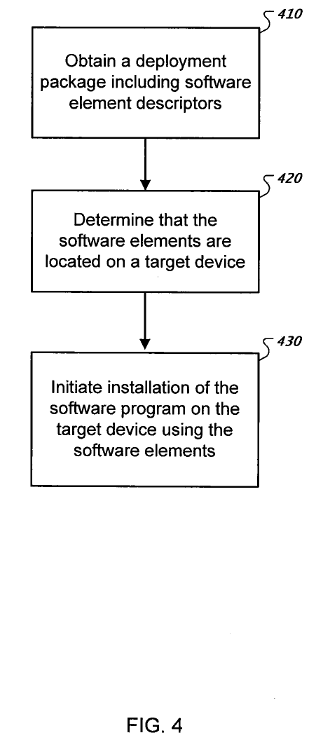

FIG. 4 is a flow chart showing an example method of installing software. The method includes obtaining local and remote files included in a deployment package to install a software program.

A deployment package can be obtained 410. The deployment package can include software element descriptors corresponding to software elements used to install a software program. In some implementations, the deployment package is cross platform.

A determination is made 420 that the software elements are located on a target device. The software elements can be located on the target device as part of a previous installation of the software program or as part of another program.

Installation of the software program is initiated 430 on the target device using the software elements. In some implementations, an installable image is created using first software element and the second software element. Initiating installation of the software program can include initiating installation using the installable image.

In some implementations, an installable package is created from the installable image, where the installable package is platform specific. Initiating installation can include initiating installation using the installable package.

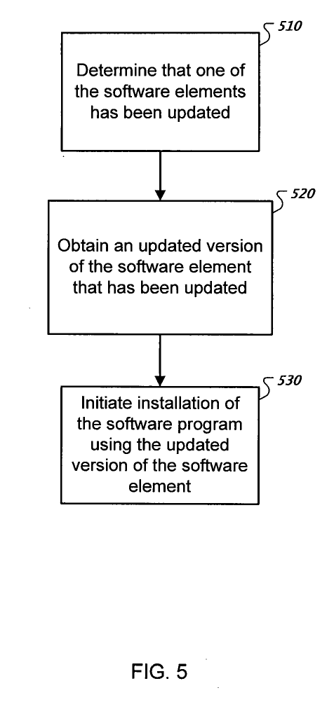

FIG. 5 is a flow chart showing another example method of installing software. The method includes obtaining updated versions of software elements and installing the software program with the updated version of the software elements.

A determination can be made that one of the software elements included in the software program has been updated 510. The files included in the updated software element are downloaded 520 and the files from all of the software elements that are used to install the software program that are currently on the device are copied into a directory along with the files included in the updated software element. The software program is installed 530 from the files in the directory.

The updated software elements may also include dependencies. The dependencies can be recursively satisfied as described above. In some implementations, the update logic (downloading, re-assembling, etc.) can handled by a program (or program invocation) distinct from the software program itself. In other implementations, the update logic is handled by the software program itself.

A first signature associated with each of the software elements that are downloaded can also be validated using the software program.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method performed by data processing apparatus, the method comprising:
receiving information regarding software elements, which form a software program, each of the software elements including one or more files;
creating software element descriptors corresponding to the software elements, wherein each software element descriptor specifies the one or more files that are included in a respective software element; and
generating a deployment package including the software element descriptors for installation of the software program, wherein each software element is separately addable and updatable in the software program, using a corresponding software element descriptor, after the software program has been installed on a computer.

2. The method of claim 7, wherein the software element descriptors are stored as metadata in the deployment package.

3. The method of claim 7, wherein each software element includes a version.

4. The method of claim 7, wherein each of the software elements are platform specific.

5. The method of claim 7, wherein the software element descriptors are cross-platform descriptors.

6. The method of claim 7, wherein the software element descriptors define dependencies between a respective software element and other software elements.

7. The method of claim 1, wherein each software element can be local or remote to a device on which the software program is installed, and wherein at least one of the software elements is separately addable in the software program after the software program has been installed on the computer by the software program receiving an indication of desired use of the at least one of the software elements and requesting an installer to re-install the software program with the least one of the software elements added therein.

8. A non-transitory computer storage medium encoded with a computer program, the program comprising instructions that when executed by data processing apparatus cause the data processing apparatus to perform operations comprising:
obtaining a deployment package including software element descriptors, the software element descriptors corresponding to software elements used to install a software program;
determining that the software elements are located on a target device; and
initiating installation of the software program on the target device using the software elements.

9. The computer storage medium of claim 8, wherein the operations further comprise:
receiving, after the software program is installed on the target device, an indication of desired use of a first feature associated with the software program;
determining that a first software element corresponding to the first feature is not located on the target device;
downloading the first software element from a remote site;
initiating installation of the first software element into the previously installed software program; and
providing functionality associated with the first feature.

10. The computer storage medium of claim 9, wherein the operations further comprise:
determining a second software element descriptor requires a third software element to be installed before a second software element corresponding to the second software element descriptor can be installed;
determining that the third element is not located on the target device;
downloading the third software element from a remote site; and
initiating installation of the second and the third software element.

11. The computer storage medium of claim 9, wherein the operations further comprise:
creating an installable image using the software elements.

12. The computer storage medium of claim 9, wherein the operations further comprise:
creating an installable package from the installable image, wherein the installable package is platform specific.

13. The computer storage medium of claim 12, wherein initiating installation of the software program includes:
initiating installation using the installable package.

14. The computer storage medium of claim 11, wherein initiating installation of the software program includes:
initiating installation using the installable image.

15. The computer storage medium of claim 9, wherein the software elements are located on the target device as part of a previous installation of the software program.

16. The computer storage medium of claim 9, wherein the operations further comprise:
determining that one of the software elements has been updated;
obtaining an updated version of the software element that has been updated; and
initiating installation of the software program using the updated version of the software element.

17. The computer storage medium of claim 9, wherein the software element descriptors are stored as metadata in the installable package.

18. The computer storage medium of claim 9, wherein each software element includes a version.

19. The computer storage medium of claim 9, wherein the software element descriptors define dependencies between a respective software element and other software elements.

20. The computer storage medium of claim 9, wherein the operations further comprise:
identifying a signature associated with the first software element; and
validating the signature using the software program.

21. A system comprising:
a user device; and
one or more computers operable to interact with the device and to perform operations comprising:
obtaining a deployment package including software element descriptors, the software element descriptors corresponding to software elements used to install a software program;
determining that the software elements are located on a target device; and
initiating installation of the software program on the target device using the software elements.
